(19) United States
(12) Patent Application Publication
(10) Pub. No.: US 2026/0087321 A1
(43) Pub. Date: Mar. 26, 2026

(54) System and Method for Prevalidating and Securing User Interactions Utilizing Bayesian Neural Networks and Robotic Process Automation

(71) Applicant: Bank of America Corporation, Charlotte, NC (US)

(72) Inventors: Bikash Dash, Hyderabad (IN); Meera Lakshmi, Chennai (IN); Manojkumar Ramesh, Tamil Nadu (IN); Karthikeyan Raja, Chennai (IN)

(21) Appl. No.: 18/891,005

(22) Filed: Sep. 20, 2024

(51) Int. Cl. G06N 3/047; G06N 7/01

(52) U.S. Cl. CPC G06N 3/047; G06N 7/01

(57) ABSTRACT

A system includes a memory configured to store a set of input data and processor operably coupled to the memory and configured to access the set of input data, execute a rule-based model configured to identify an encoding process, execute a first machine-learning model trained to encode the set of input data based on the encoding process and generate a reduced set of input data, transform the reduced set of input data from a one-dimensional probability distribution to a multidimensional probability distribution, execute a second machine-learning model trained to decode the reduced set of input data and generate a global set of input data based on the decoded reduced set of input data. In response to identifying a probable difference between the reduced set and the global set of input data, the processor is configured to identify the set of input data as corresponding to a set of misrepresentative data.

### TECHNICAL FIELD

The present disclosure relates generally to computing security, and, more specifically, to a system and method for prevalidating and securing user interactions utilizing Bayesian neural networks and robot process automation.

### BACKGROUND

Certain web-based environments may include data being exchanged and stored across any number of computing systems and databases. For example, the data may include various user data or service data that may be stored to databases associated with respective entities, and that user data or service data may be exchanged between various centralized or decentralized servers and various computing systems for servicing end users. However, such web-based environments may be sometimes subjected to various threats and cyberattacks.

### SUMMARY

The system and methods implemented by the system as disclosed in the present disclosure provide technical solutions to the technical problems discussed above by prevalidating and securing user interactions utilizing Bayesian neural networks and robot process automation. The disclosed system and methods provide several practical applications and technical advantages. Specifically, the present embodiments improve the security, reliability, and maintainability of software applications, systems, and sensitive user data, as well as the one or more processors and memory on which the software applications, systems, and sensitive user data may be executed and stored.

Specifically, the present embodiments provide a threat intelligence and detection system that utilizes one or more robotic process automation (RPA) “bots” and a variational Bayesian neural network (VBNN) engine (e.g., combined Bayesian neural network (BNN) and variational neural network (VNN)) trained to identify whether user inputted data associated with a website or a web-based service corresponds to trustable data (e.g., data corresponding to “real” and “legitimate” web-based services, websites, emails, messages, widgets, push notifications, popups, and so forth) or misrepresentative data (e.g., data corresponding to “fake” or “scam” web-based services, websites, emails, messages, widgets, push notifications, popups, and so forth) in real-time or near real-time before the execution of a requested user interaction or sensitive data transfer is initiated and completed.

Thus, the present embodiments may identify, isolate, and preempt potential threats, adversarial attacks, cyberattacks, data breaches, deceptive operations (e.g., “scams”), or other security vulnerabilities that may be associated with software applications, systems, and the transfer of sensitive user data. Specifically, by identifying in real-time or near real-time misrepresentative data during pending user interactions or sensitive data transfers, the present embodiments may identify real-time or near real-time threats and deceptive operations (e.g., “scams”) and actively reconfigure the software application, system, or sensitive user data to prevent a potential threat or deceptive operation (e.g., “scam”) with respect to the software application, system, and/or sensitive user data before an execution of the user interaction or sensitive data transfer is initiated and completed.

Moreover, by preempting potential user interactions or sensitive data transfers in association with misrepresentative data before the execution of the user interaction or the sensitive data transfer is initiated and completed, the present embodiments may reduce unnecessary calls or queries to the databases into which sensitive data may be stored, and may thereby improve computer network efficiency, bandwidth, and data throughput.

Furthermore, by training and utilizing a variational Bayesian neural network (VBNN) engine (e.g., a combined Bayesian neural network (BNN) and variational neural network (VNN)) to identify whether input data associated with a website or a web-based service corresponds to trustable data or misrepresentative data, the VBNN engine—as a consequence of its architecture (e.g., encoder-decoder neural networks)—may also provide an estimate of an uncertainty of prediction and decision-making capability in encoder-decoder neural networks.

This may lead to improved accuracy and efficiency in the predictions and decision-making capability of the VBNN engine, and, by extension, may reduce the training time and execution time of the VBNN engine due to the learned parameters (e.g., trained weights) of the VBNN engine being identified and generated in much more streamlined manner. That is, a total number of iterations of backpropagation for accurately training the VBNN engine may be minimized. In this way, the improved accuracy and efficiency in the predictions and decision-making capability of the VBNN engine may reduce processor execution times, processing workloads, and memory storage requirements of the processor and memory on which the VBNN engine is trained and executed.

The present embodiments are directed to systems and methods for prevalidating and securing user interactions utilizing Bayesian neural networks and robot process automation. In particular embodiments, a system includes a memory may be configured to store a set of input data. For example, in one embodiment, the set of input data may include a set of source data received from one or more potentially misrepresentative data sources. In particular embodiments, the system further includes one or more processors operably coupled to the memory may be configured to receive a request to initiate an execution of one or more user interactions in accordance with the set of input data.

In particular embodiments, in response to receiving the request to initiate the execution of one or more user interactions in accordance with the set of input data, the one or more processors may be further configured to access the set of input data. In particular embodiments, the one or more processors may be further configured to execute a rule-based model configured to identify, based at least in part on a modality of the set of input data, one or more encoding processes to be executed for encoding the set of input data. For example, in one embodiment, the rule-based model may include one or more robot process automation (RPA) chatbots configured to receive the request and to identify, based at least in part on the modality of the set of input data and the request, the one or more encoding processes.

In particular embodiments, the one or more processors may be further configured to execute a first machine-learning model trained to 1) encode the set of input data based at least in part on the identified one or more encoding processes and 2) generate a reduced set of input data based at least in part on the encoded set of input data. In particular embodiments, the one or more processors may be further configured to transform the reduced set of input data from comprising a one-dimensional probability distribution to comprising a multidimensional probability distribution. In particular embodiments, the one or more processors may be further configured to execute a second machine-learning model trained to 1) decode the reduced set of input data comprising the multidimensional probability distribution based at least in part on the identified one or more encoding processes and 2) generate a global set of input data based at least in part on the decoded reduced set of input data.

For example, in particular embodiments, the one or more processors may be configured to execute a variational Bayesian neural network (VBNN), in which the VBNN may include the first machine-learning model and the second machine-learning model. In one embodiment, the first machine-learning model may include a statistical probabilistic neural network (SPNN) encoder. In one embodiment, the second machine-learning model may include a statistical probabilistic neural network (SPNN) decoder.

In particular embodiments, in response to identifying a probable difference between the reduced set of input data and the global set of input data, the one or more processors may be further configured to identify the set of input data as corresponding to a set of misrepresentative data. In particular embodiments, in response to identifying the set of input data as corresponding to the set of misrepresentative data, the one or more processors may be further configured to forgo the initiation of the execution of the one or more user interactions. In particular embodiments, the one or more encoding processes may include one or more of a linear predictive coding (LPC) process, a low-delay code excited linear predictive (LD-CELP) process, or a Huffman coding process.

In particular embodiments, the probable difference between the reduced set of input data and the global set of input data may include a high probable difference. In particular embodiments, in response to identifying a low probable difference between the reduced set of input data and the global set of input data, the one or more processors may be configured to identify the set of input data as not corresponding to the set of misrepresentative data. In particular embodiments, in response to identifying the set of input data as not corresponding to the set of misrepresentative data, the one or more processors may be configured to allow the initiation of the execution of the one or more user interactions.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a cloud computing system, in accordance with certain aspects of the present disclosure;

FIG. 2 illustrates a workflow diagram of an embodiment of a threat intelligence and detection system, in accordance with one or more embodiments of the present disclosure; and

FIG. 3 illustrates a flowchart of an example method for prevalidating and securing user interactions utilizing Bayesian neural networks and robot process automation, in accordance with one or more embodiments of the present disclosure.

### DETAILED DESCRIPTION

### Example System

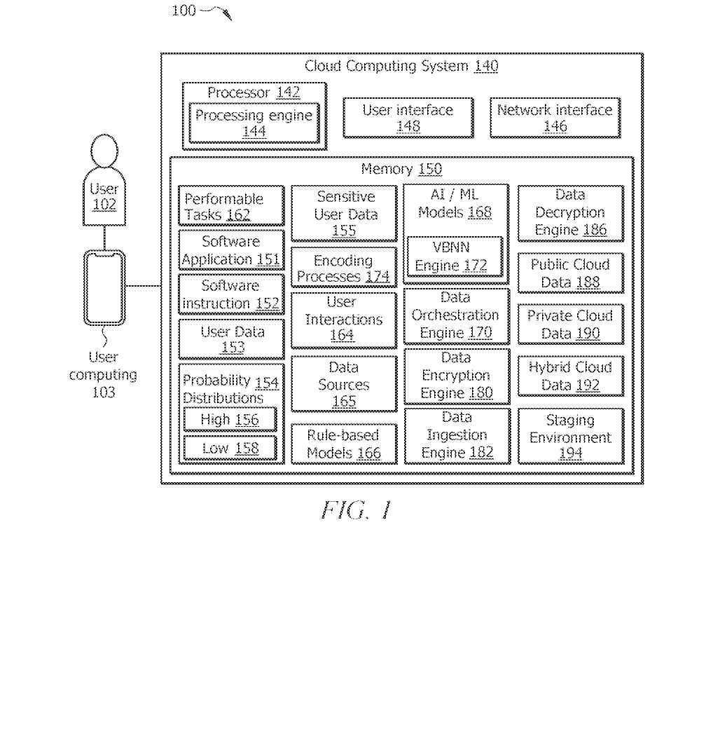

FIG. 1 is a block diagram of a system 100 that includes a user computing device 103 associated with a user 102, a cloud computing system 140, and a network 110. In particular embodiments, the user 102 may include a user associated with an institution, an organization, or an entity and that is associated with the sensitive user profile data 155. The sensitive user profile data 155 that may be associated with one or more of a large number of users external to the institution, the organization, or the entity. The network 110 enables communications and exchanges of data among components of the system 100. In other embodiments, the system 100 may not have all of the components listed and/or may have other elements instead of, or in addition to, those listed above.

In particular embodiments, the cloud computing system 140 may include a processor 142 in signal communication with a memory 150. The memory 150 stores software instructions 152 that when executed by the processor 142, cause the processor 142 to perform one or more functions described herein. For example, when the software instructions 152 are executed, the processor 142 executes a processing engine 144 prevalidate and securing user interactions 164 and sensitive user data 155 utilizing Bayesian neural networks and robot process automation in accordance with the presently disclosed embodiments.

The cloud computing system 100 may be configured as shown, or in any other configuration. In accordance with the presently disclosed embodiments, the cloud computing system 140 may be suitable for prevalidating and securing user interactions utilizing Bayesian neural networks and robot process automation. In one embodiment, the cloud computing system 140 may include a private cloud computing and storage system, which may include, for example, a cloud computing environment and infrastructure that may be managed, controlled, and dedicated to a single organization or entity.

In another embodiment, the cloud computing system 140 may include a hybrid cloud computing and storage system, which may include, for example, a mixed computing environment and infrastructure in which software applications are executing utilizing some combination of computing, storage, and services in both private cloud environments and public cloud environments. Still, in another embodiment, the cloud computing system 140 may include a public cloud computing and storage system, which may include, for example, a cloud computing environment and infrastructure that may be serviced to any number of organizations or entities as virtual resources accessible over the internet.

### System Components

### Network

The network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Cloud Computing System

In particular embodiments, the cloud computing system 140 may include any computing system that may be utilized to process data and communicate with computing devices (e.g., user computing device 103), databases, systems, etc., via the network 110. The cloud computing system 140 may be utilized to oversee operations of the processing engine 144. In particular embodiments, the cloud computing system 140 may include the processor 142 in signal communication with a network interface 146, a user interface 148, and memory 150. The cloud computing system 140 may be configured as shown, or in any other configuration.

The processor 142 may include one or more processors operably coupled to the memory 150. The processor 142 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor 142 may be a programmable logic device, a microcontroller, a microprocessor, or any suitable combination of the preceding. The processor 142 may be communicatively coupled to and in signal communication with the network interface 146, user interface 148, and memory 150. The one or more processors may be utilized to process data and may be implemented in hardware, software, or some combination thereof.

For example, the processor 142 may be 8-bit, 16-bit, 32-bit, 64-bit or of any other suitable architecture. The processor 142 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors 142 are configured to implement various instructions. For example, the one or more processors may be utilized to execute software instructions 152 to implement the functions disclosed herein, such as some or all of those described with respect to FIGS. 1-3. In some embodiments, the function described herein is implemented using logic units, FPGAs, ASICs, DSPs, or any other suitable hardware or electronic circuitry.

The network interface 146 may be utilized to enable wired and/or wireless communications (e.g., via the network 110). The network interface 146 may be utilized to communicate data between the cloud computing system 140 and other network devices, systems, or domain(s). For example, the network interface 146 may comprise a WIFI interface, a local area network (LAN) interface, a wide area network (WAN) interface, a modem, a switch, or a router. The processor 142 is configured to send and receive data using the network interface 146. The network interface 146 may be configured to use any suitable type of communication protocol.

The memory 150 may be volatile or non-volatile and may include a read-only memory (ROM), random-access memory (RAM), ternary content-addressable memory (TCAM), dynamic random-access memory (DRAM), and static random-access memory (SRAM), or other non-transitory computer-readable medium. Memory 150 may be implemented using one or more disks, tape drives, solid-state drives, and/or the like. Memory 150 may be operable to store the software instructions 152, user data 153, calculated probability distributions 154 including low probabilities 156 and high probabilities 158, user interactions 164, performable tasks 162, source data 165, rule-based models 166, one or more machine-learning models 168, a variational Bayesian neural network (VBNN) engine 172, a data orchestration engine 170, a data encryption engine 180, a data ingestion engine 182, a data decryption engine 186, public cloud data 188, private cloud data 190, hybrid cloud data 192, staging environment module 194, and/or any other data, instructions, or compute engines. The software instructions 152 may include any suitable set of instructions, logic, rules, or code operable to execute the processor 142.

The memory 150 may also store instances of software application 151 that may be executing within the cloud computing system 100. In one embodiment, the instances of a software application 151 may include any number of instances a large software application suitable for hosting and servicing thousands or millions of individual users and that may also interact via user computing devices 103 with the cloud computing system 140, and may be further associated with the sensitive user data 155.

### Processing Engine

Processing engine 144 may be implemented by the processor 142 executing the software instructions 152, and may be utilized for prevalidating and securing user interactions utilizing Bayesian neural networks and robot process automation. In particular embodiments, the processing engine 144 may monitor the user data 153, user interactions 164, and/or source data 165. In particular embodiments, the processing engine 144 may execute the one or more machine-learning models 168, such as one or more of a language model (LM), a large language model (LLM), one or more transformer-based machine-learning models, one or more sequence-to-sequence (Seq2Sec) models, or other similar machine-learning models 168.

In one embodiment, the one or more machine-learning models 168 may include a variational Bayesian neural network (VBNN) engine 172. For example, in particular embodiments, the VBNN engine 172 may include a combined Bayesian neural network (BNN) and variational neural network (VNN) that may operate individually or in conjunction to generate a prediction of a data output based on a set of input data along with an estimate of an uncertainty of the one or more machine-learning models (e.g., encoder-decoder neural networks) utilized to generate the prediction of the data output.

### Public Cloud Computing and Private Cloud Computing Data

In particular embodiments, the user data 153, user interactions 164, and/or source data 165 may include various data sourced from a number of different data sources to be ingested into the cloud computing system 140. In one embodiment, the source data 165 may include a set of potentially misrepresentative data (e.g., data collected from one or more known or potential “fake” or “scam” web-based services, websites, emails, messages, widgets, push notifications, popups, and so forth) that may be utilized to train and fine-tune the VBNN engine 172 to distinguish between trustable data and misrepresentative data by computing probability distributions 154 in accordance with the presently disclosed embodiments.

In particular embodiments, the source data 165 may be sourced from any number of disparate data sources including, for example, public cloud data 188 (e.g., crowd-sourced data), private cloud data 190 (e.g., proprietary data), hybrid cloud data 192 (e.g., a combination of crowd-sourced data and proprietary data), institutional data (e.g., national vulnerability database (NVD), common vulnerability exposures (CVE)), or any of various publicly-available or available privately-held data that may be utilized to train and fine-tune the VBNN engine 172 to distinguish between trustable data and misrepresentative data by computing probability distributions 154 in accordance with the presently disclosed embodiments. In particular embodiments, the processing engine 144 may further train the one or more machine-learning models 168 based on the user data 153, user interactions 164, and/or source data 165.

### Training and Fine-tuning AI / ML Models

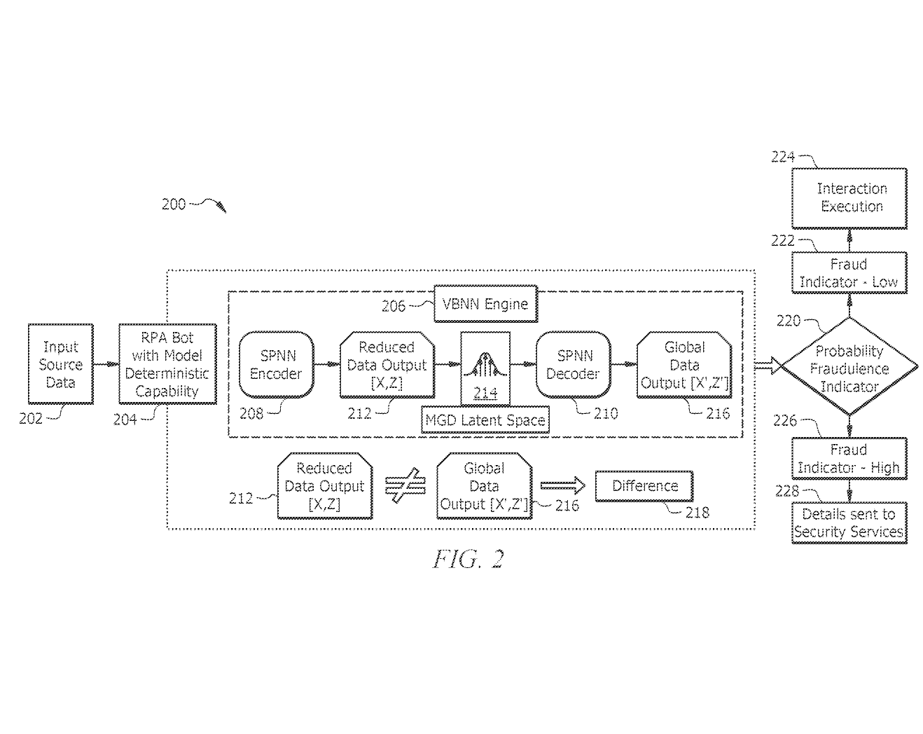

In particular embodiments, as will be greater appreciated below with respect to FIG. 2, training and fine-tuning the VBNN engine 172 may include, for example, preprocessing the various source data 165 (e.g., public cloud data 188, private cloud data 190, hybrid cloud data 192) utilizing the staging environment module 194, ingesting the various source data 165 into the cloud computing system 140 utilizing the data ingestion engine 182, and providing the ingested data sources to the rule-based models 166 utilizing the data orchestration engine 170. The various source data 165 (e.g., public cloud data 188, private cloud data 190, hybrid cloud data 192) may be provided to the data encryption engine 180 and/or data decryption engine 186 based on, for example, whether the source data 165 includes public cloud data 188 and/or private cloud data 190.

In particular embodiments, as will be discussed in greater detail with respect to FIG. 2, the rule-based models 166 may include one or more robotic process automation (RPA) “bots” (e.g., software-based robots) that utilize intelligent automation to execute various performable tasks 162 (e.g., otherwise repetitive tasks, cumbersome tasks, and so forth) without additional user 102 input. In one embodiment, the one or more RPA “bots” may determine a modality (e.g., voice, text, image, video, and so forth) of input source data 165 and identify one or more encoding processes 174 for encoding the inputted source data 165.

In particular embodiments, the inputted source data 165 may be then provided to the VBNN engine 172, which may first encode the inputted source data 165 in accordance with the identified one or more encoding processes 174. The VBNN engine 172 may be then trained and fine-tuned utilizing the inputted and encoded source data 165 the VBNN engine 172 to distinguish between trustable data and misrepresentative data by computing probability distributions 154 in accordance with the presently disclosed embodiments.

### Prevalidating and securing user interactions utilizing Bayesian neural networks and robot process automation

Embodiments of the present disclosure discuss techniques for prevalidating and securing user interactions utilizing Bayesian neural networks (BNNs) and robot process automation.

FIG. 2 illustrates a workflow diagram of an embodiment of a threat intelligence and detection system 200 for prevalidating and securing user interactions utilizing Bayesian neural networks (BNNs) and robot process automation, in accordance with certain aspects of the present disclosure. In particular embodiments, the workflow of the threat intelligence and detection system 200 may be performed utilizing the cloud computing system 140 as described above with respect to FIG. 1. As depicted, the workflow of the threat intelligence and detection system 200 may begin with accessing a set of input data 202.

In one embodiment, the set of input data 202 may include a set of potentially misrepresentative data (e.g., data collected from one or more websites, emails, text messages, multimedia messages, and so forth) that may be associated with a pending user interaction or a sensitive data transfer. For example, in one embodiment, the user 102 may request to execute a user interaction or a sensitive data transfer, and the user 102 may then provide the set of input data 202 to the cloud computing system 140 for prevalidating and securing the pending user interaction or sensitive data transfer prior to an execution of the requested user interaction or sensitive data transfer.

In particular embodiments, the workflow of the threat intelligence and detection system 200 may then continue with the set of input data 202 being provided to a robotic process automation (RPA) “bot” 204 (e.g., software-based robot). In particular embodiments, the RPA bot 204 may include a rule-based model that may be suitable for automatedly performing one or more tasks in response to receiving the input of the set of input data 202 and in accordance with one or more predetermined rules. For example, in one embodiment, in response to receiving the set of input data 202, the RPA bot 204 may identify a modality (e.g., voice, text, image, video, and so forth) of the set of input data 202.

In particular embodiments, the RPA bot 204 may then identify one or more encoding processes 174 to be executed for encoding the set of input data 202 based on the modality (e.g., voice, text, image, video, and so forth) of the set of input data 202. For example, in one embodiment, the one or more encoding processes 174 may include one or more of a linear predictive coding (LPC) process, a low-delay code excited linear predictive (LD-CELP) process, a Huffman coding process, or other similar encoding / decoding process that may be selected to optimize encoding / decoding of the set of input data 202 based on the identified modality (e.g., voice, text, image, video, and so forth) of the set of input data 202.

In particular embodiments, the workflow of the threat intelligence and detection system 200 may then continue with the set of input data 202 being provided to a variational Bayesian neural network (VBNN) engine 206. In particular embodiments, the VBNN engine 206 may include a number of machine-learning models that may be trained end-to-end (E2E) or utilizing a probabilistic principal components analysis (PCA) meta-algorithm for prevalidating and securing user interactions in accordance with the presently disclosed embodiments. For example, in one embodiment, the VBNN engine 206 may include a combined Bayesian neural network (BNN) and variational neural network (VNN) that may operate individually or in conjunction to generate a prediction of a data output based on the set of input data 202 along with an estimate of an uncertainty of the one or more machine-learning models (e.g., encoder-decoder neural networks) utilized to generate the prediction of the data output.

For example, in one embodiment, the BNN may include a framework for estimating uncertainty of one or more machine-learning models (e.g., encoder-decoder neural networks) by introducing a probability distribution over their weights to determine inputs for which the one or more machine-learning models (e.g., encoder-decoder neural networks) predictions are different as an estimation of uncertainty in their outputs. In another example, the VNN may include defined sublayers of the one or more machine-learning models (e.g., encoder-decoder neural networks) to generate parameters for the output probability distribution of the layer of the one or more machine-learning models (e.g., encoder-decoder neural networks), in which the generated parameters may include a mean and a variance of Gaussian probability distribution.

For example, as further illustrated by FIG. 2, the VBNN engine 206 may include a statistical probabilistic neural network (SPNN) encoder 208 and a statistical probabilistic neural (SPNN) decoder 210. In particular embodiments, the SPNN encoder 208 may include an encoder (e.g., encoder of autoencoder, encoder of a variational autoencoder (VAE), a transformer-based encoder, a convolutional neural network (CNN) based encoder) that may be trained to generate a reduced data output 212 (e.g., probability distribution) based on the set of input data 202. For example, in one embodiment, the SPNN encoder 208 may first encode the set of input data 202 in accordance with the suitable encoding process 174 (e.g., LPC process, LD-CELP process, Huffman coding process, and so forth).

Upon the initial encoding of the set of input data 202, the SPNN encoder 208 may then generate a mean and a variance of each dimension of latent space as the reduced data output 212 and then map the reduced data output 212 into a multivariate Gaussian distribution 214. Specifically, in one embodiment, the SPNN encoder 208 may be trained to map the reduced data output 212 into the multivariate Gaussian distribution 214, for example, by transforming the reduced data output 212 from including a one-dimensional probability distribution to including a multidimensional probability distribution.

In particular embodiments, upon the multivariate Gaussian distribution 214 being generated, the SPNN decoder 210 may then sample the multivariate Gaussian distribution 214 and receive the multivariate Gaussian distribution 214 as an input for decoding. For example, in particular embodiments, the SPNN decoder 210 may include a decoder (e.g., decoder of autoencoder, decoder of a VAE, a transformer-based decoder, a CNN-based decoder) that may be trained to generate a global data output 216 (e.g., probability distribution) based on a sampling of one or more mean and variance parameters defining the multivariate Gaussian distribution 214 and a decoding of the multivariate Gaussian distribution 214 in accordance with the previous encoding process 174 (e.g., LPC process, LD-CELP process, Huffman coding process, and so forth) utilized to encode the set of input data 202.

Specifically, in one embodiment, the SPNN decoder 210 may be trained to generate the global data output 216, for example, by sampling the one or more mean and variance parameters defining the multivariate Gaussian distribution 214 and reconstructing the reduced data output 212 as generated by the SPNN encoder 208. Thus, because the SPNN encoder 208 may be trained to generate a mean and a variance of each dimension of latent space as the reduced data output 212 and then map the reduced data output 212 into a multivariate Gaussian distribution 214 and the SPNN decoder 210 may be trained to reconstruct the reduced data output 212 based on a sampling of the multivariate Gaussian distribution 214.

In particular embodiments, the VBNN engine 206 may then calculate a probable difference 218 (e.g., a loss) between the reduced data output 212 as generated by the SPNN encoder 208 and the global data output 216 as generated by the SPNN decoder 210. For example, in one embodiment, the VBNN engine 206 may calculate a Kullback–Leibler (KL) divergence loss between the reduced data output 212 as generated by the SPNN encoder 208 and the global data output 216 as generated by the SPNN decoder 210. Specifically, the probable difference 218 (e.g., KL divergence loss) may include a statistical distance calculated between the reduced data output 212 and the global data output 216.

In particular embodiments, based on the calculated probable difference 218 (e.g., KL divergence loss) between the reduced data output 212 and the global data output 216, the VBNN engine 206 may then provide the calculated probable difference 218 (e.g., KL divergence loss) to a misrepresentative data indicator 220. For example, in particular embodiments, the misrepresentative data indicator 220 may receive the calculated probable difference 218 (e.g., KL divergence loss) and then compare the calculated probable difference 218 (e.g., KL divergence loss) to a predetermined loss threshold.

For example, in one embodiment, based on whether the calculated probable difference 218 (e.g., KL divergence loss) satisfies the loss threshold, the misrepresentative data indicator 220 may indicate the original set of input data 202 as corresponding to one of trustable data 222 (e.g., data corresponding to “real” and “legitimate” web-based services, websites, emails, messages, widgets, push notifications, popups, and so forth) or misrepresentative data 226 (e.g., data corresponding to “fake” or “scam” web-based services, websites, emails, messages, widgets, push notifications, popups, and so forth, and so forth).

In particular embodiments, upon the misrepresentative data indicator 220 identifying the original set of input data 202 as corresponding to trustable data 222 (e.g., data corresponding to “real” and “legitimate” web-based services, websites, emails, messages, widgets, push notifications, popups, and so forth), the pending user interaction or sensitive data transfer may be allowed to be executed (e.g., interaction execution 224) in accordance with the presently disclosed embodiments. On the other hand, upon the misrepresentative data indicator 220 identifying the original set of input data 202 as corresponding to misrepresentative data 226 (e.g., data corresponding to “fake” or scam web-based services, websites, emails, messages, widgets, push notifications, popups, and so forth), the pending user interaction or sensitive data transfer may be terminated and the original set of input data 202 may be flagged and stored to system security services 228 for additional training, retraining, and/or fine-tuning of the VBNN engine 206.

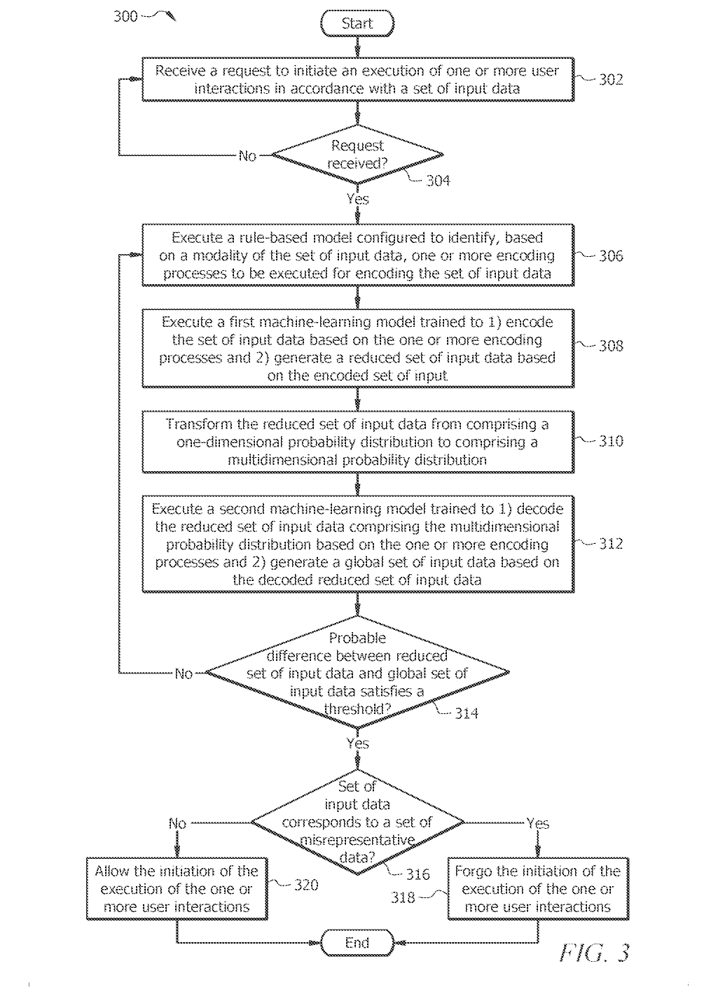

FIG. 3 illustrates a flowchart of an example method 300 for prevalidating and securing user interactions utilizing Bayesian neural networks (BNNs) and robot process automation, in accordance with one or more embodiments of the present disclosure. The method 300 may be performed utilizing the cloud computing system 140 as described above with respect to FIG. 1. The method 300 may begin at block 302 with the cloud computing system 140 receiving a request to initiate an execution of one or more user interactions in accordance with a set of input data. For example, in one embodiment, the user 102 may request to execute a user interaction and the user 102 may then provide the set of input data 202 to the cloud computing system 140 for prevalidating and securing the pending user interaction prior to an execution of the requested user interaction.

The method 300 may then continue at decision 304 with the cloud computing system 140 confirming whether a request to execute a user interaction has been received from the user 102. In one embodiment, confirming that the request to execute a user interaction has not been received from the user 102, the method 300 may return to block 302 as discussed above. On the other hand, in response to confirming that the request to execute a user interaction has been received from the user 102, the method 300 may then continue at block 306 with the cloud computing system 140 executing a rule-based model configured to identify, based on a modality of the set of input data, one or more encoding processes to be executed for encoding the set of input data.

For example, in one embodiment, in response to receiving the set of input data 202, the RPA bot 204 may identify a modality (e.g., voice, text, image, video, and so forth) of the set of input data 202 and further identify one or more encoding processes 174 (e.g., LPC process, LD-CELP process, Huffman coding process, and so forth) for encoding the set of input data 202. The method 300 may then continue at block 308 with the cloud computing system 140 executing a first machine-learning model trained to 1) encode the set of input data based on the one or more encoding processes and 2) generate a reduced set of input data based on the encoded set of input.

For example, in one embodiment, the SPNN encoder 208 may be trained to encode the set of input data 202 and generate a reduced data output 212 (e.g., probability distribution) based on the encoded set of input data 202. The method 300 may then continue at block 310 with the cloud computing system 140 transforming the reduced set of input data from comprising a one-dimensional probability distribution to comprising a multidimensional probability distribution. For example, in one embodiment, the SPNN encoder 208 may be trained to map the reduced data output 212 into the multivariate Gaussian distribution 214, for example, by transforming the reduced data output 212 from including a one-dimensional probability distribution to including a multidimensional probability distribution.

The method 300 may then continue at block 312 with the cloud computing system 140 executing a second machine-learning model trained to 1) decode the reduced set of input data comprising the multidimensional probability distribution based on the one or more encoding processes and 2) generate a global set of input data based on the decoded reduced set of input data. For example, in one embodiment, the SPNN decoder 210 may be trained to generate the global data output 216 (e.g., probability distribution) based on a sampling of one or more mean and variance parameters representative of the multivariate Gaussian distribution 214 and a decoding of the multivariate Gaussian distribution 214 in accordance with the previous encoding process 174 (e.g., LPC process, LD-CELP process, Huffman coding process, and so forth) utilized to encode the set of input data 202.

The method 300 may then continue at decision 314 with the cloud computing system 140 determining whether a probable difference between the reduced set of input data and the global set of input data satisfies a threshold. For example, in one embodiment, the misrepresentative data indicator 220 may receive the calculated probable difference 218 (e.g., KL divergence loss) and then compare the calculated probable difference 218 (e.g., KL divergence loss) to a predetermined loss threshold. In response to determining that the probable difference between the reduced set of input data and the global set of input data fails to satisfy the loss threshold, the method 300 may return to block 306 as discussed above.

In particular embodiments, in response to determining that the probable difference between the reduced set of input data and the global set of input data satisfies the loss threshold, the method 300 may then continue at decision 316 with the cloud computing system 140 determining whether the set of input data corresponds to a set of misrepresentative data. In particular embodiments, in response to determining that the set of input data 202 corresponds to a set of misrepresentative data, the method 300 may continue at block 318 with the cloud computing system 140 forgoing an initiation of the execution of the one or more user interactions requested by the user 102. On the other hand, in response to determining that the set of input data 202 does not correspond to a set of misrepresentative data, the method 300 may conclude at block 320 with the cloud computing system 140 allowing the initiation of the execution of the one or more user interactions requested by the user 102.

Thus, in accordance with the presently disclosed embodiments, the threat intelligence and detection system 200 may improve the security, reliability, and maintainability of software applications, systems, and sensitive user data, as well as the one or more processors 142 and memory 150 on which the software applications 151, systems, and sensitive user data may be executed and stored. Specifically, the present embodiments provide a threat intelligence and detection system 200 that utilizes one or more robotic process automation (RPA) “bots” and a variational Bayesian neural network (VBNN) engine (e.g., a combined Bayesian neural network (BNN) and variational neural network (VNN)) trained to identify whether user 102 inputted data associated with a website or a web-based service corresponds to trustable data (e.g., data corresponding to “real” and “legitimate” web-based services, websites, emails, messages, widgets, push notifications, popups, and so forth) or misrepresentative data (e.g., data corresponding to “fake” or “scam” web-based services, websites, emails, messages, widgets, push notifications, popups, and so forth) in real-time or near real-time before the execution of a requested user interaction or sensitive data transfer is initiated and completed.

Thus, the present embodiments may identify, isolate, and preempt potential threats, adversarial attacks, cyberattacks, data breaches, deceptive operations (e.g., “scams”), or other security vulnerabilities that may be associated with software applications, systems, and the transfer of sensitive user data. Specifically, by identifying in real-time or near real-time misrepresentative data during pending user interactions or sensitive data transfers, the present embodiments may identify real-time or near real-time threats and deceptive operations (e.g., “scams”) and actively reconfigure the software application, system, or sensitive user data to prevent a potential threat or deceptive operation (e.g., “scam”) with respect to the software application, system, and/or sensitive user data before an execution of the user interaction or sensitive data transfer is initiated and completed.

Moreover, by preempting potential user interactions or sensitive data transfers in association with misrepresentative data before the execution of the user interaction or the sensitive data transfer is initiated and completed, the present embodiments may reduce unnecessary calls to, or queries of, the databases (e.g., memory 150) into which sensitive data may be stored, and may thereby improve computer network efficiency, bandwidth, and data throughput.

Furthermore, by training and utilizing a variational Bayesian neural network (VBNN) engine (e.g., a combined Bayesian neural network (BNN) and variational neural network (VNN)) to identify whether input data associated with a website or a web-based service corresponds to trustable data or misrepresentative data, the VBNN engine—as a consequence of its architecture (e.g., encoder-decoder neural networks)—may also provide an estimate of an uncertainty of prediction and decision-making capability in encoder-decoder neural networks.

This may lead to improved accuracy and efficiency in the predictions and decision-making capability of the VBNN engine, and, by extension, may reduce the training time and execution time of the VBNN engine due to the learned parameters (e.g., trained weights) of the VBNN engine being identified and generated in much more streamlined manner. That is, a total number of iterations of backpropagation for accurately training the VBNN engine may be minimized. In this way, the improved accuracy and efficiency in the predictions and decision-making capability of the VBNN engine may reduce processor 142 execution times, processor 142 workloads, and memory 150 storage requirements of the processor 142 and memory 150 on which the VBNN engine is trained and executed.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a set of input data, wherein the set of input data comprises a set of source data received from one or more potentially misrepresentative data sources; and
one or more processors operably coupled to the memory and configured to:
receive a request to initiate an execution of one or more user interactions in accordance with the set of input data, and, in response:
access the set of input data;
execute a rule-based model configured to identify, based at least in part on a modality of the set of input data, one or more encoding processes to be executed for encoding the set of input data;
execute a first machine-learning model trained to 1) encode the set of input data based at least in part on the identified one or more encoding processes and 2) generate a reduced set of input data based at least in part on the encoded set of input data;
transform the reduced set of input data from comprising a one-dimensional probability distribution to comprising a multidimensional probability distribution;
execute a second machine-learning model trained to 1) decode the reduced set of input data comprising the multidimensional probability distribution based at least in part on the identified one or more encoding processes and 2) generate a global set of input data based at least in part on the decoded reduced set of input data;
in response to identifying a probable difference between the reduced set of input data and the global set of input data, identify the set of input data as corresponding to a set of misrepresentative data; and
in response to identifying the set of input data as corresponding to the set of misrepresentative data, forgo the initiation of the execution of the one or more user interactions.

2. The system of claim 1, wherein the one or more processors are further configured to execute a variational Bayesian neural network (VBNN), and wherein the VBNN comprises the first machine-learning model and the second machine-learning model.

3. The system of claim 2, wherein the first machine-learning model comprises a statistical probabilistic neural network (SPNN) encoder.

4. The system of claim 2, wherein the second machine-learning model comprises a statistical probabilistic neural network (SPNN) decoder.

5. The system of claim 1, wherein the rule-based model comprises one or more robot process automation (RPA) bots configured to receive the request and to identify, based at least in part on the modality of the set of input data and the request, the one or more encoding processes.

6. The system of claim 5, wherein the one or more encoding processes comprises one or more of a linear predictive coding (LPC) process, a low-delay code excited linear predictive (LD-CELP) process, or a Huffman coding process.

7. The system of claim 1, wherein the probable difference between the reduced set of input data and the global set of input data comprises a high probable difference, and wherein the one or more processors are further configured to:
in response to identifying a low probable difference between the reduced set of input data and the global set of input data, identify the set of input data as not corresponding to the set of misrepresentative data; and
in response to identifying the set of input data as not corresponding to the set of misrepresentative data, allow the initiation of the execution of the one or more user interactions.

8. A method, comprising:
receiving a request to initiate an execution of one or more user interactions in accordance with a set of input data, and, in response:
accessing a set of input data, wherein the set of input data comprises a set of source data received from one or more potentially misrepresentative data sources;
executing a rule-based model configured to identify, based at least in part on a modality of the set of input data, one or more encoding processes to be executed for encoding the set of input data;
executing a first machine-learning model trained to 1) encode the set of input data based at least in part on the identified one or more encoding processes and 2) generate a reduced set of input data based at least in part on the encoded set of input data;
transforming the reduced set of input data from comprising a one-dimensional probability distribution to comprising a multidimensional probability distribution;
executing a second machine-learning model trained to 1) decode the reduced set of input data comprising the multidimensional probability distribution based at least in part on the identified one or more encoding processes and 2) generate a global set of input data based at least in part on the decoded reduced set of input data;
in response to identifying a probable difference between the reduced set of input data and the global set of input data, identifying the set of input data as corresponding to a set of misrepresentative data; and
in response to identifying the set of input data as corresponding to the set of misrepresentative data, forgoing the initiation of the execution of the one or more user interactions.

9. The method of claim 8, further comprising executing a variational Bayesian neural network (VBNN), wherein the VBNN comprises the first machine-learning model and the second machine-learning model.

10. The method of claim 9, wherein the first machine-learning model comprises a statistical probabilistic neural network (SPNN) encoder.

11. The method of claim 9, wherein the second machine-learning model comprises a statistical probabilistic neural network (SPNN) decoder.

12. The method of claim 8, wherein the rule-based model comprises one or more robot process automation (RPA) bots configured to receive the request and to identify, based at least in part on the modality of the set of input data and the request, the one or more encoding processes.

13. The method of claim 8, wherein the one or more encoding processes comprises one or more of a linear predictive coding (LPC) process, a low-delay code excited linear predictive (LD-CELP) process, or a Huffman coding process.

14. The method of claim 8, wherein the probable difference between the reduced set of input data and the global set of input data comprises a high probable difference, the method further comprising:
in response to identifying a low probable difference between the reduced set of input data and the global set of input data, identifying the set of input data as not corresponding to the set of misrepresentative data; and
in response to identifying the set of input data as not corresponding to the set of misrepresentative data, allowing the initiation of the execution of the one or more user interactions.

15. A non-transitory computer-readable medium storing instructions that, when executed by one or more processors, cause the one or more processors to:
receive a request to initiate an execution of one or more user interactions in accordance with a set of input data, and, in response:
access a set of input data, wherein the set of input data comprises a set of source data received from one or more potentially misrepresentative data sources;
execute a rule-based model configured to identify, based at least in part on a modality of the set of input data, one or more encoding processes to be executed for encoding the set of input data;
execute a first machine-learning model trained to 1) encode the set of input data based at least in part on the identified one or more encoding processes and 2) generate a reduced set of input data based at least in part on the encoded set of input data;
transform the reduced set of input data from comprising a one-dimensional probability distribution to comprising a multidimensional probability distribution;
execute a second machine-learning model trained to 1) decode the reduced set of input data comprising the multidimensional probability distribution based at least in part on the identified one or more encoding processes and 2) generate a global set of input data based at least in part on the decoded reduced set of input data;
in response to identifying a probable difference between the reduced set of input data and the global set of input data, identify the set of input data as corresponding to a set of misrepresentative data; and
in response to identifying the set of input data as corresponding to the set of misrepresentative data, forgo the initiation of the execution of the one or more user interactions.

16. The non-transitory computer-readable medium of claim 15, wherein the instructions further cause the one or more processors to execute a variational Bayesian neural network (VBNN), and wherein the VBNN comprises the first machine-learning model and the second machine-learning model.

17. The non-transitory computer-readable medium of claim 16, wherein the first machine-learning model comprises a statistical probabilistic neural network (SPNN) decoder.

18. The non-transitory computer-readable medium of claim 16, wherein the second machine-learning model comprises a statistical probabilistic neural network (SPNN) decoder.

19. The non-transitory computer-readable medium of claim 15, wherein the rule-based model comprises one or more robot process automation (RPA) bots configured to receive the request and to identify, based at least in part on the modality of the set of input data and the request, the one or more encoding processes.

20. The non-transitory computer-readable medium of claim 19, wherein the one or more encoding processes comprises one or more of a linear predictive coding (LPC) process, a low-delay code excited linear predictive (LD-CELP) process, or a Huffman coding process.
